(19) United States
(12) Patent Application Publication
(10) Pub. No.: US 2024/0273513 A1
(43) Pub. Date: Aug. 15, 2024

(54) MOBILE DEVICE APPLICATION FOR ACCOUNT SELECTION ON MULTI-ACCOUNT CARD

(71) Applicant: VISA INTERNATIONAL SERVICE ASSOCIATION, SAN FRANCISCO, CA (US)

(72) Inventors: Hendy Wong, San Ramon, CA (US); Sarah Jane Galamay, San Francisco, CA (US); Chung-Hsun Lee, San Francisco, CA (US); Roger Williams, San Francisco, CA (US); Yuexi Chen, Foster City, CA (US)

(73) Assignee: VISA INTERNATIONAL SERVICE ASSOCIATION, SAN FRANCISCO, CA (US)

(21) Appl. No.: 18/689,843

(22) PCT Filed: Sep. 14, 2022
(86) PCT No.: PCT/US2022/043486

§ 371 Date: Mar. 6, 2024

Related U.S. Application Data
(60) Provisional application No. 63/244,178, filed on Sep. 14, 2021.

(51) Int. Cl. G06Q 20/34

(52) U.S. Cl. CPC G06Q 20/3572; G06Q 20/3574

(57) ABSTRACT

Embodiments provide an NDEF interface on a co-badged user card (e.g., a payment card storing multiple payment applications or accounts) to modify the payment application selection status on the co-badged card using a mobile application provided on a user device with NDEF support. The NDEF interface on the co-badged card allows communication with the mobile application stored on the user device operating a variety of operating systems (e.g., iOS and Android).

### CROSS-REFERENCES TO RELATED APPLICATIONS

This application claims benefit under 35 USC § 119(e) to U.S. Provisional Patent Application No. 63/244,178 filed Sep. 14, 2021 and entitled “Mobile Device Application For Account Selection On Multi-Account Card”, the disclosure of which is incorporated by reference herein in its entirety for all purposes.

### BACKGROUND

Co-badged payment cards store account credentials for multiple payment networks (e.g., associated with multiple applications of different payment networks) on the same card. The challenge of a co-badged payment card is allowing the cardholder to choose one of the available payment applications on the co-badged card. If there are multiple payment accounts (e.g., each associated with a different payment application) installed on one payment card, the card provides the list of the applications to the terminal (e.g., point of sale (POS) terminals) at the beginning of the card-terminal interaction, optionally together with priority indicators. Then the logic on the terminal or cardholder interaction on the terminal (e.g., press buttons on terminal to make a list item selection among the displayed card applications) decides which payment application (e.g., which account) is selected for processing the transaction, which will be next selected by terminal for further card-terminal interaction.

Merchant terminals (e.g., POS) which are already deployed in the field may not be able to support co-badged card applications choice, e.g., not display correctly a payment network application and a choice; ignore a payment network application in favor for another network's payment application; ignore application priority indicators on the card and always select other network's application by default. The terminals installed in the field are difficult to update, thus the support of new cards which carry a new card application developed after the terminal deployment is difficult.

While some card products added a screen, or other features on the card, the structure required a battery to be incorporated in the card, thereby increasing the complexity of the card. The cost of manufacture of such card is 5˜20 times more expensive than the normal chip payment card, the durability of such card is low comparing with normal chip payment card because of extra components on the card. Another drawback of such design is that the cardholder selection on the card using buttons has to be done purposely before the payment transaction, which downgrades the user experience. Another drawback of such design is that the battery has to be recharged regularly, or the feature/card stops working when battery is exhausted. In addition, the battery is a chemical, non-environmentally friendly component. Moreover, cards usually get bent, and it is of a concern for on-card battery cards as replacing such a card is more costly.

Currently, iOS devices (e.g., iPhone, iPad, Apple Watch, etc.) do not allow mobile applications (e.g., banking applications, payment applications) stored on those devices to have Near-Field Communication (NFC) access to user cards (e.g., payment cards). Such iOS devices support NFC data exchange format (NDEF), which is not supported on a conventional payment card (e.g., an EMV contactless card).

Embodiments address these and other problems, individually and collectively.

### BRIEF SUMMARY

Embodiments provide a user card including a memory for storing one or more applications and data associated with the applications, the user card comprises a first payment application, a second payment application, a communication interface and a selection application. The communication interface is configured to transmit data associated with the first payment application and the second payment application to a mobile application on a user device. The communication interface is also configured to receive an input associated with at least one of the first payment application or the second payment application. The communication interface is further configured to modify the data associated with the first payment application and the second payment application based on the input. The input sets a status of at least one of the first payment application or the second payment application to an active payment application. The selection application is configured to transmit data associated with one or more active payment applications to a terminal.

Embodiments further provide a method comprising detecting, by a user device, a co-badged card in communication proximity. The method further includes retrieving, by a mobile application on the user device, data associated with at least a first payment application and a second payment application stored on the co-badged card. The method also includes displaying, by the user device, a list including at least the first payment application and the second payment application. The method further includes receiving, by the user device, an input associated with at least one of the first payment application and the second payment application. The method includes detecting, by the user device, the co-badged card in communication proximity. The method further includes modifying, by the mobile application on the user device, the data associated with at least the first payment application and the second payment application on the co-badged card.

Embodiments further provide a user device comprising a processor, and a memory storing a mobile application and instructions that, when executed by the processor, cause the processor to: detect a co-badged card in communication proximity; retrieve, by the mobile application, data associated with at least a first payment application and a second payment application stored on the co-badged card; display a list including at least the first payment application and the second payment application; receive an input associated with at least one of the first payment application and the second payment application; detect the co-badged card in communication proximity; and modify, by the mobile application, the data associated with at least the first payment application and the second payment application on the co-badged card.

These and other embodiments are described in further detail below.

### BRIEF DESCRIPTION OF THE DRAWINGS

FIG. 1 shows a diagram of a user card interacting with a mobile application on a user device, according to various embodiments.

FIG. 2 illustrates an exemplary mobile application on a user device interacting with a co-badged user card, according to various embodiments.

FIG. 3 illustrates a user selecting an account on an exemplary co-badged user card using a mobile application on a user device during a transaction, according to various embodiments.

FIG. 4 illustrates initiation and processing of a transaction using a card storing multiple user-selectable payment applications, according to various embodiments.

FIG. 5 illustrates an exemplary flowchart of steps for modifying data associated with a payment application on a co-badged card using a mobile application on a user device, according to various embodiments.

### DETAILED DESCRIPTION

Embodiments provide an a Near Field Communication (NFC) Data Exchange Format (NDEF) interface on a co-badged user card (e.g., a payment card storing multiple payment applications, or multiple account data) to change the payment application selection status on the co-badged card using a user device (e.g., a mobile communication device) storing a mobile application with NDEF support. The NDEF interface on the co-badged card allows communication with mobile application stored on the user device operating a variety of operating systems (e.g., iOS and Android).

An exemplary user card (e.g., a co-badged payment card) may be in communication with a user device (e.g., a smartphone). The user card may include a first payment application (e.g., a first account), a second payment application (e.g., a second account), a Proximity Payment System Environment (PPSE) application that includes a list of available payment applications on the user card, and an NDEF interface that exchanges data with a smartphone application stored on the user device. The first and second applications may comply with existing EMV standards (contact and contactless). According to some embodiments, the user card may include any number of payment applications, and the number of payment applications is not limited to two.

Prior to discussing various embodiments, some terms can be described in further detail.

A “user” may include an individual. In some embodiments, a user may be associated with one or more personal accounts and/or payment devices. The user may also be referred to as a cardholder, account holder, or consumer in some embodiments.

A “user card” may be a compact and handheld portable device operated by a user. The user card may be small enough to fit into a wallet, pocket, or purse. The user card may be associated with one or more payment accounts issued by one or more authorizing authorities or issuers. Examples of user cards may include payment cards such as credit cards, smart cards, gift cards, payroll cards, healthcare cards, a discount or loyalty card. An exemplary user card may be associated with a cryptocurrency spending account. A payment device may be used by a user as part of an authentication or authorization process. For example, a user may present a user card to an access device in order to authenticate the user, or a user may present a user card at an access device (e.g., a point of sale (POS) terminal) as part of performing a transaction with a merchant. A user card may possess a user card interface, enabling the payment device to communicate with other devices, such as access devices, point of sale terminals, or enrollment devices. A user card may include a volatile or a non-volatile memory to store information. A user card may possess a biometric device, enabling the payment device to collect biometric information, such as fingerprints or thumbprints. According to various embodiments, a user card may include a co-badged card (e.g., a multi-application card) storing multiple payment applications thereon. The multiple payment applications may be issued by a same issuer, or by different issuers.

A “user device” may be any suitable electronic device that can process and communicate information to other electronic devices. The user device may include a processor and a computer-readable medium coupled to the processor, the computer-readable medium comprising code, executable by the processor. The user device may also each include an external communication interface for communicating with each other and other entities. The user device may also be referred as a mobile communication device. Examples of user devices may include a smartphone, a laptop or desktop computer, a tablet, a wearable device, etc.

An “access device” may be any suitable device that provides access to a remote system. An access device may also be used for communicating with a resource provider computer, a processing server computer, or any other suitable system. An access device may generally be located in any suitable location, such as at the location of a resource provider or merchant. An access device may be in any suitable form. Some examples of access devices include POS or point of sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, terminals, and the like. An access device may use any suitable contact or contactless mode of operation to send or receive data from, or associated with, a payment device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a payment device and/or mobile device. Other examples of access devices include devices (e.g., locks, gates, access control boxes, etc.) that control physical access to locations (e.g., venues, transit stations, homes, offices, buildings, etc.), as well as software devices that control access to data or information.

A “resource provider” may be an entity that can provide a resource such as goods, services, information, and/or access. Examples of resource providers includes merchants, data providers, transit agencies, governmental entities, venue and dwelling operators, etc. A resource provider may operate a resource provider computer.

A “merchant” may typically be an entity that engages in transactions and can sell goods or services, or provide access to goods or services.

An “authorizing entity” may be an entity that authorizes a request. Examples of an authorizing entity may be an issuer, a governmental agency, a document repository, an access administrator, etc. An authorizing entity may operate an authorizing entity computer.

An “issuer” may typically refer to a business entity (e.g., a bank) that maintains an account for a user that is associated with a user card. An issuer may also issue account parameters associated with the account. An issuer may be associated with a host system that performs some or all of the functions of the issuer on behalf of the issuer.

A “processing server computer” may include a server computer used for processing transactions from a transaction processing network. In some embodiments, the processing server computer may be coupled to a database and may include any hardware, software, other logic, or combination of the preceding for servicing the requests from one or more client computers or user devices. The processing server computer may comprise one or more computational apparatuses and may use any of a variety of computing structures, arrangements, and compilations for servicing the requests from one or more client computers or user devices. In some embodiments, the processing server computer may operate multiple server computers. In such embodiments, each server computer may be configured to process a transaction for a given region or handles transactions of a specific type based on transaction data.

The processing server computer may include data processing subsystems, networks, and operations used to support and deliver authorization services, exception file services, and clearing and settlement services. An exemplary processing server computer may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system, which performs clearing and settlement services. The processing server computer may use any suitable wired or wireless network including the Internet.

The processing server computer may process transaction-related messages (e.g., authorization request messages and authorization response messages) and determine the appropriate destination computer (e.g., issuer computer/authorizing authority computer) for the transaction-related messages. In some embodiments, the processing server computer may authorization transactions on behalf of an issuer. The processing server computer may also handle and/or facilitate the clearing and settlement of financial transactions.

“Authorization processing” or “authorization operations” may include at least determining whether to authorize a transaction. Authorization processing may be executed responsive to receiving a notification that a prior step in a transaction has been completed. Alternatively, or additionally, authorization processing may include generating and sending an authorization request message and/or authorization response message.

“Transaction data” or “transaction details” may refer to information associated with a transaction. For example, transaction data may include one or more of an authorized amount (e.g., transaction amount, item value, etc.), other amount, terminal country code, terminal verification results, transaction currency code, transaction date, transaction type (e.g., card-present transaction, high value transaction, low value transaction, local transaction, international transaction, etc.), an unpredictable number, application interchange profile (AIP), application transaction counter (ATC), issuer application data (IAD), etc.

The term “message” may include any data or information that may be transported from one entity to another entity (e.g., one computing device to another computing device). Messages may be communicated internally between devices/components within a computer or computing system or externally between devices over a communications network. Additionally, messages may be modified, altered, or otherwise changed to comprise encrypted or anonymized information.

A “processor” may refer to any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer-readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers.

Embodiments provide various features that may be applicable to user cards, including co-badged user cards.

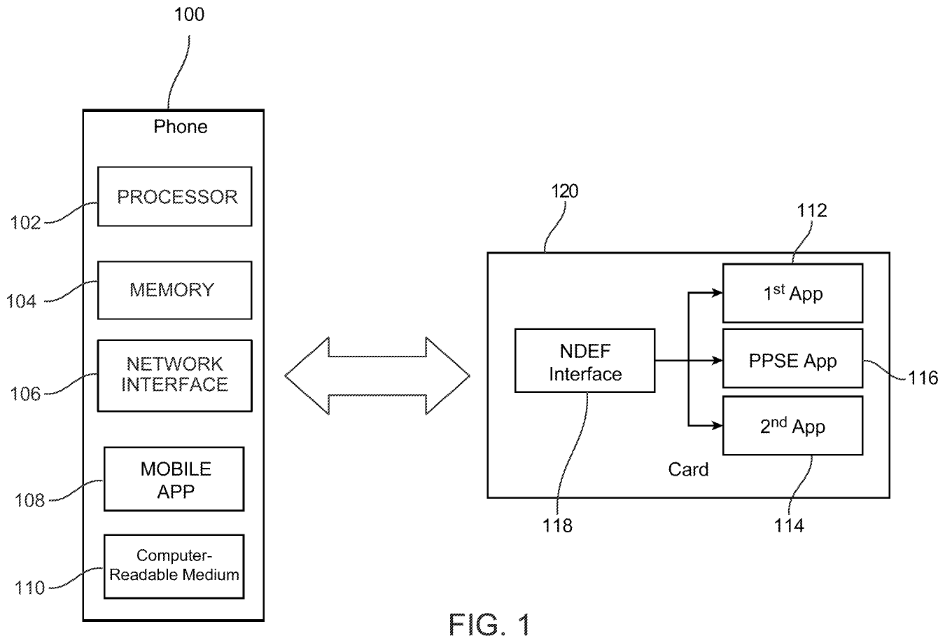

FIG. 1 shows a diagram of a user card interacting with a mobile application on a user device, according to various embodiments.

An exemplary user card may include a co-badged payment card 120 as shown in FIG. 1. The co-badged payment card 120 may store account credentials for multiple accounts associated with various transaction processing networks (e.g., associated with payment applications from multiple transaction processing networks) on the same card. For example, the co-badged card 120 may store a first payment application 112 associated with a first account (e.g., an international or global payment application/account) and a second payment application 114 associated with a second account (e.g., a domestic payment application/account). The first payment application 112 may be associated with a first transaction processing network (e.g., transactions initiated using the first payment application are processed by the first transaction processing network). The second payment application 114 may be associated with a second transaction processing network (e.g., transactions initiated using the first payment application are processed by the first transaction processing network), thereby making the user card a “co-badged card”.

In some embodiments, the second account may include a loyalty points account associated with the first account. In other embodiments, the first account or the second account may include a blockchain address for cryptocurrency spending.

The co-badged card 120 may further include a selection application 116 (e.g., a PPSE application). The selection application 116 on a contactless card contains the list of all card applications supported by the contactless interface, and is returned from the card in response to the reader (e.g., the terminal, the access device) issuing a “select” command for the PPSE application. According to various embodiments, the selection application 116 may include a PPSE application with NDEF encapsulation. The PPSE application supports at least two application identifiers (AIDs), one per payment application. The PPSE application supports NDEF read command/operation to retrieve the supported card application AIDs, priority and status (e.g., enabled/disabled), as well the NDEF write command/operation to change the card application priority and status on the co-badged card 120.

Embodiments provide a way for the user to select one of the multiple payment applications stored on the card by using a mobile application 108 provided on a user device 100 (e.g., a smart device, a mobile phone, a tablet). Accordingly, the user does not have to interact with a terminal by, for example, touching the terminal. The user may select a payment application prior to presenting the co-badged payment card 120 to the terminal during a transaction.

According to various embodiments, the co-badged card 120 may include a substrate, an electronic circuit embedded on the substrate, an antenna embedded on the substrate, and a memory embedded on the substrate. The memory may be electrically coupled to one or more of the electronic circuit, the antenna, and the communication interface. According to various embodiments, the memory may also store account information (e.g., payment credentials) associated with a plurality of accounts.

According to various embodiments, when the co-badged card 120 is brought in proximity of a terminal or a user device, the co-badged card 120 gets powered up. For example, a user may tap or insert the co-badged card 120 in the terminal or the user device. The terminal or the user device may include an antenna configured to interact with the co-badged card 120. According to the embodiments, the co-badged card 120 does not have a battery so the co-badged card 120 may need to be tapped or dipped in another device to get power from the interaction with the other device. For example, the co-badged card 120 may power up upon entering in a magnetic field of the terminal or the user device (e.g., the co-badged card 120 is powered through magnetic induction). An antenna embedded in the co-badged card 120 may act like a coil when the co-badged card 120 is within the electromagnetic field created by the terminal or the user device. Current induced on the antenna of the co-badged card 120 by the electromagnetic field may be used to power an electronic circuit connected to the antenna. The terminal or the user device may be inductively coupled (e.g., magnetically coupled) to the co-badged card 120 when the terminal provides energy to the co-badged card 120. Once powered, the co-badged card 120 starts executing the computer code stored on the memory of the co-badged card 120. Accordingly, the co-badged card 120 is passively powered.

FIG. 1 further illustrates a user device 100 that comprises a processor 102, a memory 104, a network interface 106, the mobile application 108, and a computer-readable medium 110. Computer-readable medium 110 may store code executable by the processor for implementing some or all of the functions of user device 100 described herein.

The processor 102 may be implemented as one or more integrated circuits (e.g., one or more single core or multicore microprocessors and/or microcontrollers). The processor 102 may be used to control the operation of the user device 100. The processor 102 can execute a variety of programs in response to program code or computer-readable code stored in memory 104. The processor 102 may include functionality to maintain multiple concurrently executing programs or processes.

The memory 104 may be implemented using any combination of any number of non-volatile memories (e.g., flash memory) and volatile memories (e.g., DRAM, SRAM), or any other non-transitory storage medium, or a combination of media.

The network interface 106 may be configured to connect to one or more communication networks to allow the user device 100 to communicate with other entities such as a terminal of a merchant, the co-badged card 120, a cellular network, etc. Some examples of network interface 106 may include a physical network interface (such as a Network Interface Card (NIC)), a virtual network interface, a communications port, or the like. The wireless protocols enabled by network interface 106 may include Bluetooth®, and/or Wi-Fi™. According to various embodiments, the user device 100 may be configured for near-field communication (NFC).

Embodiments provide a mobile application 108 on the user device 100 that can be used to interact with one or more of the payment applications (e.g., the first payment application 112, the second payment application 114) on the co-badged card 120. For example, the mobile application 108 may be used to change a selection status, priority, or preference of one or more of the payment applications (e.g., the first payment application 112, the second payment application 114) stored on the co-badged card 120. Embodiments allow the mobile application 108 to have near-field communication (NFC) access to the co-badged card 120.

Embodiments create a communication interface 118 (e.g., an NFC Data Exchange Format (NDEF) interface, or an NDEF application) on the co-badged user card 120. NDEF is a standardized data format that can be used to exchange information between any compatible NFC device and another NFC device. The communication interface 118 may be used to update an application identifier (AID) and priority for the first payment application 112 and the second payment application 114; and to create software tools (e.g., software development kits (SDKs)) appropriate per operating system (e.g., iOS SDK and Android SDK) to update the selection application (e.g., the PPSE application) 116.

According to various embodiments, the communication interface 118 may be configured to transmit data associated with the first payment application 112 and the second payment application 114 to the mobile application 108 on the user device 100. The communication interface 118 may then receive an input associated with the first payment application 112 and/or the second payment application 114, and modify the data associated with the first payment application 112 and the second payment application 114 based on the input. For example, the input may set a status of the first payment application 112 and/or the second payment application 114 to an active payment application. The selection application 115 may then transmit data associated with one or more active payment applications (e.g., the first payment application 112 and/or the second payment application 114 as activated by the user) to a terminal of a resource provider (e.g., merchant POS). For example, data associated with the active payment application(s) is provided to the terminal using a near field communication capability of the co-badged card.

On the user device 100 side, the SDK is integrated in the mobile application 108 to allow the cardholder to choose a preferred transaction processing network (e.g., the first payment application 112, the second payment application 114) on the co-badged card 120 to transact with. Embodiments support mobile and wearable devices with multiple operating systems (e.g., iOS devices, Android devices).

Embodiments use the communication interface 118 (e.g., NDEF interface) on the co-badged card 120 to read and write dynamic card configuration data (e.g., data that changes the card behavior) to the co-badged card 120. The communication interface 118 is linked with a selection application (e.g., the PPSE application) 116 on the co-badged card 120, which enables to populate the card information on the mobile application 108 stored on the user device 100, which may include an iOS device. The mobile application 108 may read the payment applications 112, 114 (e.g., accounts) from the co-badged card 120 using the communication interface 118, and allow a user to select one of the payment applications 112, 114 (e.g., accounts) to use for the next one or more transactions (e.g., tap transactions, contact transactions, contactless transactions, card-present transactions), or set a default payment application.

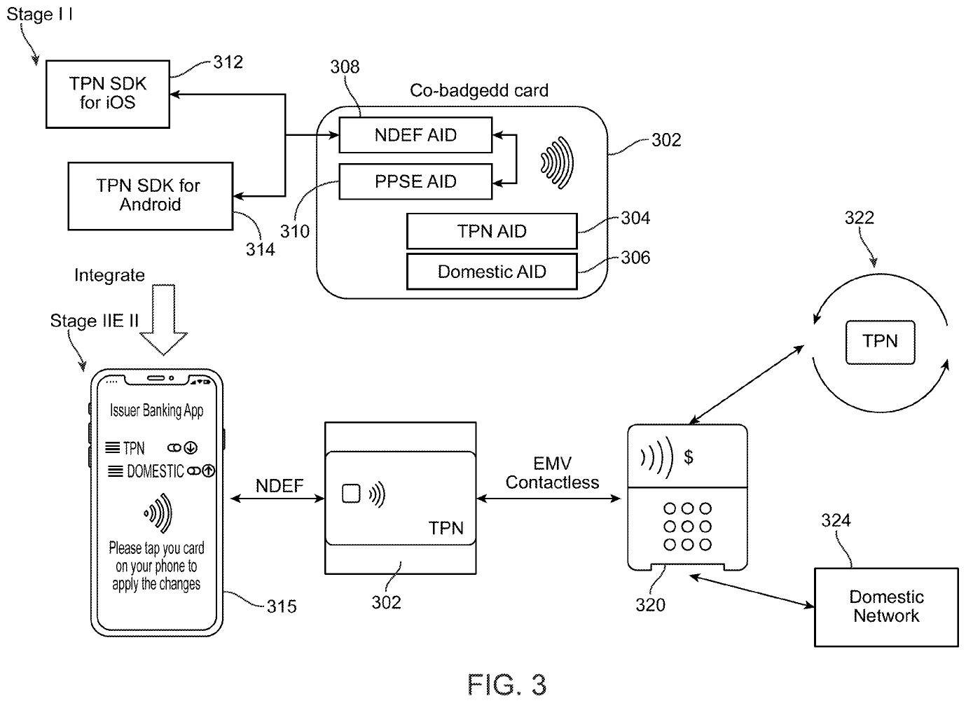

According to various embodiments, if the user prefers to have all payment applications 112, 114 to be visible to the reader terminal (e.g., POS terminal), the user may assign a priority to each payment application using the mobile application 108. Thereafter, the user card 120, through the communication interface 118, provides data associated with all payment applications 112, 114 along with their associated priorities to the reader terminal. This is discussed below in greater detail in connection with FIG. 3.

According to various embodiments, the communication interface 118 (e.g., the NDEF interface or the NDEF application) populates the card configuration of the co-badged card 120, reformats the card configuration into an NDEF message, and transmits the NDEF message to the mobile application 108 on the user device 100, which may include any Android or iOS device. The mobile application 108 may display the card configuration including the available payment application options (e.g., the first payment application 112, and the second payment application 114) on a display of the user device 100. The information displayed on the user device 100 may indicate which payment applications are on the user card, which payment applications are enabled, which payment applications are disabled, which one has a higher priority, which one has a lower priority, etc. Once presented with the information on the user device 100, the user may select a first payment application 112 to be used in the next one or more transactions (e.g., for a predetermined number of transactions, or for transactions that match a predetermined criteria, for example, based on location, amount, merchant type, etc.). The mobile application 108 creates an NDEF write command to the communication interface 118, which translates the NDEF write command into a PPSE update and instructs the selection application 116 (e.g., PPSE application) in the next transaction(s) to only show the first payment application 112 to the terminal. The terminal receives/reads the data associated with the first payment application 112 and processes the transaction using a transaction processing network (e.g., the first transaction processing network) associated with the first payment application 112.

When the communication interface 118 receives the input to set the status of the first payment application 112 and/or the second payment application 114 to an active status, the communication interface 118 may determine that the input is an NDEF write command command generated by the mobile application 108. The communication interface 118 may translate the NDEF write command into a PPSE update command. The communication interface 118 may then instruct the selection application 116 to update the status of at least one of the first payment application 112 or the second payment application 114 to the active payment application on the user card. Essentially, the NDEF write command configures the first payment application and the second payment application on the co-badged card based on the input.

In some embodiments, the input may set the status of both the first payment application 112, and the second payment application 114 to the active payment application, and assign priorities to the first payment application 112 and the second payment application 114. The priorities assigned to the active payment application(s) are transmitted to the terminal along with the data associated with those payment applications.

In other embodiments, the input may set the status of only one of the first payment application 112, or the second payment application 114 to an active payment application. The input may further set the status of the other one of the first payment application 112 or the second payment application 114 to an inactive payment application. The data associated with the inactive payment application is retained from the terminal (e.g., the co-badged card appears as a single payment application card to the terminal).

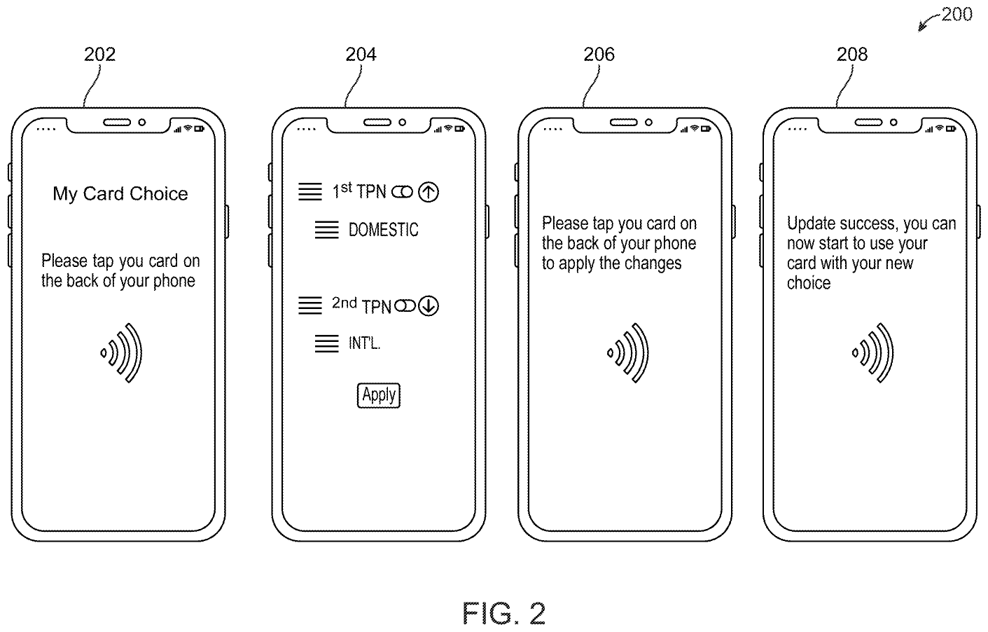

FIG. 2 illustrates an exemplary mobile application on a user device interacting with a co-badged user card, according to various embodiments. An exemplary interaction flow 200 between the mobile application of the user device and the co-badged user card may include, at 202 the mobile application on the user device being activated and ready to receive an input, such as a selection of a payment application on the co-badged user card. The mobile application may display a message on a display screen of the user device asking the user to tap the co-badged user card to the user device so that the mobile application can read from the co-badged user card. According to various embodiments, the mobile application may perform a NDEF read operation on the co-badged card via the NDEF interface of the co-badged card. The NDEF read operation retrieves the data associated with the first payment application and the second payment application.

At 204, the user device may display the information retrieved from the co-badged user card. For example, the user device may display multiple payment applications, and preferences associated with them. As shown in FIG. 2, the user interface 204 shown the first payment application and the second payment application along with a toggle button displayed next to each payment application. There are additional preferences/information displayed in connection with the payment applications, such as the first payment application being a domestic payment application and the second payment application being an international payment application. By selecting the corresponding toggle button, the user may provide an input selecting (e.g., activating or deactivating) the payment applications. For example, as shown in 204, the user may have selected the first payment application by moving the toggle right. The user may also assign priorities to the payment applications. As shown in 204, the input may further include the user assigning a higher priority (e.g., arrow pointing upward) to the first payment application and a lower priority (e.g., arrow pointing downward) to the second payment application. One of ordinary skill in the art appreciates that the user interface may be designed in many alternative manners to allow the user to select one of the displayed payment application, assign priorities, etc. The user device is configured to receive the input via touch, voice, textual (e.g., alphanumerical) input, or any other suitable way.

At 206, the user device may ask the user to bring the co-badged card in close proximity of the user device so that the user's selections may be stored on the co-badged card. For example, when the co-badged card is tapped to the user device, the mobile application on the user device may transmit an NDEF write command to the co-badged card (e.g., via the NDEF interface of the co-badged card) to modify the data associated with the payment applications on the co-badged card. For example, if the user selected the first payment application and kept the second payment application inactive, the co-badged card may now be modified to provide only the data associated with the first payment application to a terminal. That is, the co-badged card acts like a single payment application card to the terminal.

In some embodiments, the user may select both payment applications and assign priorities to the payment applications. That is, the mobile application may allow the user to assign priorities to the payment applications on the user card, without deactivating one or more of the payment applications. For example, the mobile application may allow the user to assign a first (higher) priority to the selected payment application, and assign a secondary (lower) priority to the remaining payment application(s). In communicating with the terminal or access device, the communication interface may present the payment applications along with their associated priorities. This way, the terminal will be aware of the user's preference and process the transaction using the higher priority payment application data. If the transaction cannot be successfully completed, the terminal may re-process the transaction with the lower priority payment data.

According to various embodiments, the user may also assign percentages to the payment applications on the user device. The percentages, when transmitted to a terminal from the co-badged card during a transaction, may indicate to the terminal that a first percentage of the transaction amount should be processed using the first payment application, and the remaining part of the transaction amount should be processed using the second payment application.

At 208, the user device may provide a status update to the user. For example, the user device may indicate whether the data on the co-badged card has been successfully updated. That is, the user device may display the results of the NDEF write command.

FIG. 3 illustrates a user selecting an account on an exemplary co-badged user card using a mobile application on a user device during a transaction, according to various embodiments. As provided above, a co-badged card 302 according to various embodiments include a first payment application 304 (associated with a first AID), a second payment application 306 (associated with a second AID), a communication interface 308 (e.g., an NDEF interface associated with a unique AID) and a selection application 310 (e.g., a PPSE application associated with a unique AID).

Stage I of the process illustrated in FIG. 3 depicts preparation of the co-badged card and the user device for interaction.

Embodiments provide software development kits (SDKs) for various operating systems (e.g., iOS and Android) to the co-badged card 302. For example, a first SDK 312 for an iOS operating system and a second SDK 314 for an Android system may be provided to the co-badged card 302. This way, the same co-badged card 302 will be able to communicate with mobile devices operating different operating systems (e.g., iOS and Android). An appropriate one of the SDKs 312, 314 is integrated with the user device 315 based on the operating system running on the user device 315. The SDK 312, 314 sets-up the NFC adapter on the user device 315, and performs the read NDEF records operation, and the write NDEF records operation.

Stage II of the process illustrated in FIG. 3 depicts the use of the co-badged card during a transaction

When the co-badged card 302 is within a communication distance of the user device 315, the co-badged card 302 and the user device 315 may communicate using the communication interface 308 (e.g., NDEF interface) on the co-badged card 302. When the user device 315 reads the data (e.g., payment applications) stored on the co-badged card 302, the user device 315 may display the various payment applications on the screen, along with widgets allowing the user to activate/deactivate a payment account/application or to assign priority to the payment accounts/applications. In some embodiments, the user's selection may be valid for the future transactions until the user changes the selection. In some embodiments, the user may also indicate, using the graphical user interface associated with the mobile application, whether the selection is valid for a preset number of transactions or based on transaction characteristics (e.g., a location of the merchant, an amount of the transaction, type of goods or services purchased, a type of merchant, etc.).

Once the selection is made and stored on the co-badged card 302 (as described above, for example in connection with FIG. 2), the co-badged card 302 may be brought in an operational distance to an access device (e.g., a POS terminal) 320. The communication interface 308 of the co-badged card 302 may transmit, to the access device 320, application data as set up by the user on the mobile device 315. For example, if the user enabled the first payment application and disabled the remaining payment applications on the co-badged card 302, the communication interface 308 only transmits information for the first payment application to the access device 320. Therefore, the co-badged card 302 may appear as a single-payment-application card to the access device 320. If, on the other hand, the user assigned priorities to various payment applications and enabled all payment applications, the communication interface 308 transmits, to the access device 320, a list of available payment applications along with the assigned priorities (as discussed above, for example in connection with FIG. 2).

The access device 320 may be configured to communicate, interact or otherwise process transactions with one or more transaction processing networks (e.g., the first transaction processing network 322 associated with the first payment application, a second transaction processing network 324 associated with the second payment application).

According to various embodiments, the co-badged card is passively powered (e.g., the co-badged card is powered by the terminal or access device that interacts with the co-badged card). When the user or the cardholder taps the co-badged card on a terminal or dips the co-badged card in a terminal, the co-badged card gets powered up. According to the embodiments, the co-badged card does not have a battery so the co-badged card needs to tapped or dipped to the terminal to receive power from the terminal to start executing the computer code stored on a memory of the co-badged card.

In some embodiments, once the user selects a payment application on the co-badged card via the mobile application, the co-badged card may be programmed to automatically activate the selected payment application, and de-activate the unselected payment application(s). Therefore, the co-badged card may appear as a single-application card to the terminal or access device interacting with the co-badged card. When the terminal reads data from the co-badged card, only data associated with the selected application will be available to the terminal. Therefore, the terminal is not capable of overriding the user choice using an alternate payment application stored on the co-badged card.

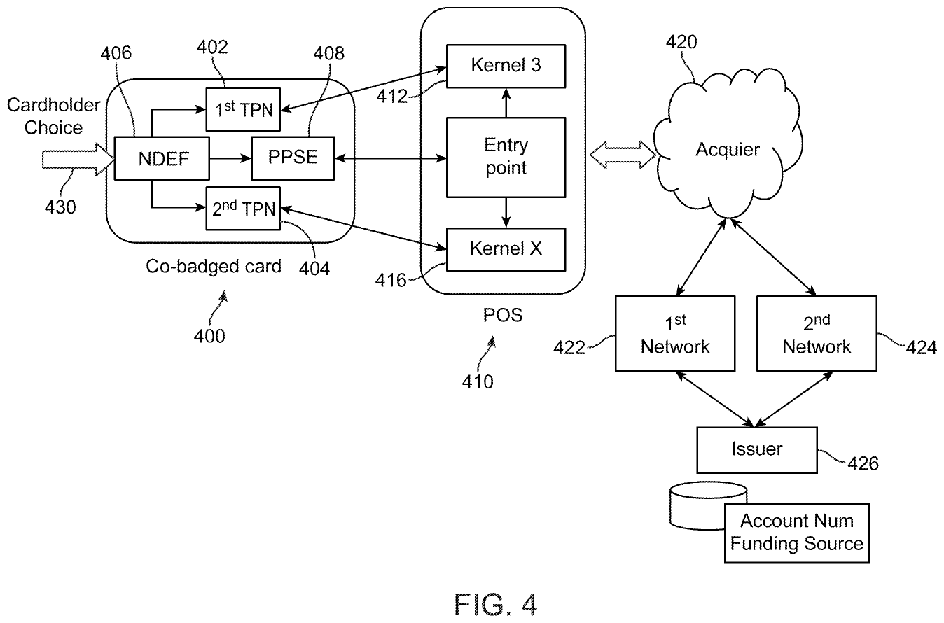

FIG. 4 illustrates initiation and processing of a transaction using a co-badged card storing multiple user-selectable payment applications, according to various embodiments. Cardholder choice indicating the first payment application 402 or the second payment application 404 is provided to the co-badged card 400 through communication 430 with a mobile application stored on a user device. For example, the cardholder choice may indicate that the first payment application 402 is selected and will be used for next transaction. The data on the co-badged card 400 may be modified via the communication interface (e.g., NDEF interface) 406 based on the user choice. For example, the communication interface 406 may modify the data on the co-badged card 400 to have only payment data associated with the first payment application 402 available for transmission to a terminal.

When the co-badged card 400 is brought in a communication distance from the terminal 410, the selection application 408 (e.g., the PPSE application) may make only payment data associated with the first payment application 402 available for transmission to the terminal 410. From the terminal's point of view, first kernel 412 interacts with the first payment application 402, and second kernel 416 interacts with the second application, the entry point activates 412 or 416 based on response returned by 408. No modification is required for the terminal 410 to interact with the co-badged card 400 that functions as described herein. Accordingly, there is no impact to existing terminal infrastructure by incorporating the user selection of payment application as described in connection with various embodiments.

Depending on which entry point 412, 416 is used to interact with payment application 402, 404 chosen by cardholder, the terminal 410 and the acquirer 420 route transaction data to the appropriate transaction processing network 422, 424. For example, following the example provided above, when the user selected payment application is the first payment application 402, account data associated with the first payment application 402 is provided to first entry point 412 of the terminal 410. Accordingly, the terminal 410 and the acquirer 420 route the transaction data including the account data associated with the first payment application 402 received from the co-badged card 400 to the first transaction processing network 422 associated with the first payment application 402. The transaction processing network 422, 424 interacts with the issuer 426 to process the transaction and generate an authorization response message. The network messaging and connection does not need modification, thus there is no impact to existing network infrastructure by the incorporating the user selection of payment application as described in connection with various embodiments.

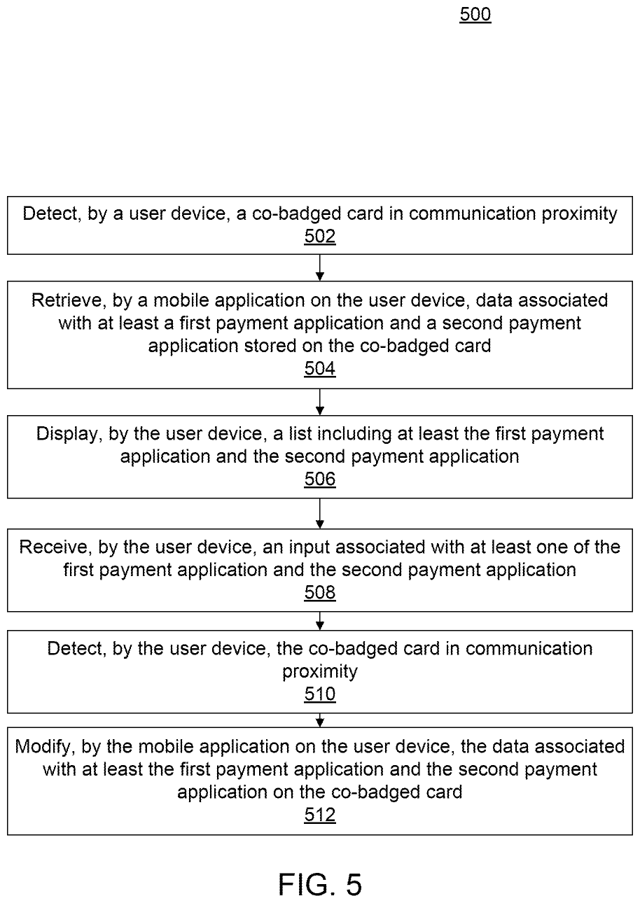

FIG. 5 illustrates an exemplary flowchart of steps for modifying data associated with a payment application on a co-badged card using a mobile application on a user device, according to various embodiments. In some implementations, one or more process blocks of FIG. 5 may be performed by a user device, such as a mobile phone or a communication device. Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

At step 502, the user device may detect a co-badged card in communication proximity of the user device. For example, the co-badged card may be a NFC enabled card. Accordingly, the user device may detect the presence of the co-badged card via NFC connection with the co-badged card.

At step 504, a mobile application on the user device may retrieve data associated with at least a first payment application and a second payment application stored on the co-badged card. For example, when the co-badged card is tapped to the user device, the mobile application on the user device may perform an NDEF read operation on the co-badged card to retrieve the data associated with the payment applications.

At step 506, the user device may display the retrieved information. For example, the user device may display a list including at least the first payment application and the second payment application. For example, the user device may display multiple payment application, and preferences associated with them.

At step 508, the user device may receive an input associated with at least one of the first payment application and the second payment application. For example, the payment applications may be displayed along with graphical elements provided next to each payment application allowing the user to provide an input for one or more of the payment applications. The user may provide an input selecting (e.g., activating or deactivating) the payment applications. The input may further include the user assigning a priority to the payment applications. The user device is configured to receive the input via touch, voice, textual (e.g., alphanumerical) input, or any other suitable way.

In some embodiments, the input may include selecting more than one payment application and assigning priorities to the payment applications. That is, the mobile application may allow the user to assign priorities to the payment applications on the user card, without deactivating one or more of the payment applications. For example, the mobile application may allow the user to assign a first (higher) priority to a selected payment application, and assign a secondary (lower) priority to the remaining payment application(s).

According to various embodiments, the input may include assigning percentages to the payment applications. The percentages, when transmitted to a terminal from the co-badged card during a transaction, may indicate to the terminal that x% of the transaction amount should be processed using the first payment application, and the remaining part of the transaction amount should be processed using the second payment application.

At step 510, the user device may detect the co-badged card in communication proximity.

At step 512, the mobile application on the user device may modify the data associated with at least the first payment application and the second payment application on the co-badged card. For example, the mobile application on the user device may perform an NDEF write command to the co-badged card (e.g., via the NDEF interface of the co-badged card) to modify the data associated with the payment applications on the co-badged card. For example, if the user selected the first payment application and kept the second payment application inactive, the co-badged card may now be modified to provide only the data associated with the first payment application to a terminal. That is, the co-badged card acts like a regular single payment application card to the terminal.

Embodiments provide many technical advantages. Embodiments provide a co-badged chip card that stores multiple user-selectable applications (e.g., payment applications, payment accounts, or other accounts). Embodiments further provide a mobile application on a user device (e.g., mobile phone) that allows the user to select one of the payment applications stored on the co-badged card, and/or assign priorities to the payment applications stored on the co-badged card. Embodiments provide a communication interface (e.g., a NDEF interface or application) on the co-badged card that allows communication with the mobile application(s) stored on the user device operating a variety of operating systems (e.g., iOS, Android). The user can select the payment application on the co-badged card without having to interact with the terminal by, for example, touching the terminal surface that is touched by multiple people throughout the day. In addition, embodiments allow the user to select a payment application prior to interacting with the terminal, thereby prior to providing available accounts information to the terminal. All these advantages are achieved without impacting the issuance, acceptance and network infrastructure.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

The above description is illustrative and is not restrictive. Many variations will become apparent to those skilled in the art upon review of the disclosure. The scope should, therefore, be determined not with reference to the above description, but instead should be determined with reference to the pending claims along with their full scope or equivalents.

One or more features from any embodiment may be combined with one or more features of any other embodiment without departing from the scope.

As used herein, the use of “a,” “an,” or “the” is intended to mean “at least one,” unless specifically indicated to the contrary.

What is claimed is:

1. A user card including a memory for storing one or more applications and data associated with the applications, the user card comprising:
a first payment application;
a second payment application;
a communication interface configured to:
transmit data associated with the first payment application and the second payment application to a mobile application on a user device,
receive an input associated with at least one of the first payment application or the second payment application,
modify the data associated with the first payment application and the second payment application based on the input, wherein the input sets a status of at least one of the first payment application or the second payment application to an active payment application; and
a selection application configured to transmit data associated with one or more active payment applications to a terminal.

2. The user card of claim 1, wherein the communication interface is an NDEF interface, and the selection application is a PPSE application with NDEF encapsulation.

3. The user card of claim 2, wherein the input is an NDEF write command generated by the mobile application, the communication interface is further configured to:
translate the NDEF write command into a PPSE update command; and
instruct the selection application to update the status of at least one of the first payment application or the second payment application to the active payment application on the user card.

4. The user card of claim 1, wherein the input sets a status of at least one of the first payment application or the second payment application to an inactive payment application, wherein data associated with the inactive payment application is retained from the terminal.

5. The user card of claim 4, wherein the data associated with one or more active payment applications include data associated with a single active payment application.

6. The user card of claim 1, wherein the input sets a priority status associated with the first payment application and the second payment application,
wherein the selection application is further configured to transmit the priority status associated with the one or more active payment applications.

7. The user card of claim 1, wherein the user card is a co-badged card storing a NDEF interface that communicates with the mobile application on the user device executing an iOS operating system.

8. The user card of claim 1, wherein the first payment application is associated with a first transaction processing network, and the second payment application is associated with a second transaction processing network.

9. The user card of claim 1, wherein the data associated with one or more active payment applications is provided to the terminal using a near field communication capability of the user card.

10. A system comprising:
the user card according to claim 1; and
a user device including a processor and a memory storing instructions that, when executed by the processor, cause the processor to
detect the user card in communication proximity;
retrieve, by a mobile application on the user device, data associated with at least the first payment application and the second payment application;
display a list including at least the first payment application and the second payment application;
receive an input associated with at least one of the first payment application and the second payment application;
detect the user card in communication proximity; and
modify, by the mobile application on the user device, the data associated with at least the first payment application and the second payment application on the user card.

11. A method comprising:
detecting, by a user device, a co-badged card in communication proximity;
retrieving, by a mobile application on the user device, data associated with at least a first payment application and a second payment application stored on the co-badged card;
displaying, by the user device, a list including at least the first payment application and the second payment application;
receiving, by the user device, an input associated with at least one of the first payment application and the second payment application;
detecting, by the user device, the co-badged card in communication proximity; and
modifying, by the mobile application on the user device, the data associated with at least the first payment application and the second payment application on the co-badged card.

12. The method of claim 11, wherein retrieving the data further comprises:
performing an NDEF read operation on the co-badged card via an NDEF interface of the co-badged card, wherein the NDEF read operation retrieves the data associated with the first payment application and the second payment application.

13. The method of claim 11, wherein modifying the data further comprises:
transmitting an NDEF write command to the co-badged card via an NDEF interface of the co-badged card, wherein the NDEF write command configures the first payment application and the second payment application on the co-badged card based on the input.

14. The method of claim 11, wherein the input includes a selection of one of the first payment application and the second payment application as a selected application.

15. The method of claim 11, wherein the input includes a priority assignment to at least one of the first payment application and the second payment application on the co-badged card.

16. The method of claim 11, wherein the user device executes an iOS operating system.

17. A user device comprising:
a processor; and
a memory storing a mobile application and instructions that, when executed by the processor, cause the processor to:
detect a co-badged card in communication proximity;
retrieve, by the mobile application, data associated with at least a first payment application and a second payment application stored on the co-badged card;
display a list including at least the first payment application and the second payment application;
receive an input associated with at least one of the first payment application and the second payment application;
detect the co-badged card in communication proximity; and
modify, by the mobile application, the data associated with at least the first payment application and the second payment application on the co-badged card.

18. The user device of claim 17, wherein retrieving the data further comprises performing an NDEF read operation on the co-badged card via an NDEF interface of the co-badged card, wherein the NDEF read operation retrieves the data associated with the first payment application and the second payment application, and
transmitting an NDEF write command to the co-badged card via an NDEF interface of the co-badged card, wherein the NDEF write command configures the first payment application and the second payment application on the co-badged card based on the input.

19. The user device of claim 17, wherein the input includes one or more of:
a selection of one of the first payment application and the second payment application as a selected application; and
a priority assignment to at least one of the first payment application and the second payment application on the co-badged card.

20. The user device of claim 17, further storing:
an iOS operating system executed by the processor on the user device.
